(19) United States
(12) Patent Application Publication
(10) Pub. No.: US 2025/0370388 A1
(43) Pub. Date: Dec. 4, 2025

(54) IMAGE FORMING APPARATUS

(71) Applicant: FUJIFILM Business Innovation Corp., Tokyo (JP)

(72) Inventors: Yuichi Nishikuni, Yokohama-shi (JP); Tatsuya Namiki, Yokohama-shi (JP); Chihiro Matsuguma, Yokohama-shi (JP); Mitsunori Shioi, Yokohama-shi (JP)

(73) Assignee: FUJIFILM Business Innovation Corp., Tokyo (JP)

(21) Appl. No.: 18/891,559

(22) Filed: Sep. 20, 2024

(30) Foreign Application Priority Data
May 29, 2024 (JP) 2024-087497

(51) Int. Cl. G03G 15/00; G03G 15/01

(52) U.S. Cl. CPC G03G 15/5054; G03G 15/0189

(57) ABSTRACT

An image forming apparatus includes: plural image forming units, each including plural image forming sections and an intermediate transfer member on which a toner image formed by the plural image forming sections is primarily transferred; a transport belt that is capable of transporting a recording medium on which a toner image of the intermediate transfer member of each of the plural image forming units is secondarily transferred and that is capable of secondarily transferring the toner image of the intermediate transfer member of each of the plural image forming units; a first detection section that detects the toner image on a downstream side of a most downstream secondary transfer position; a recording medium supply section that supplies the recording medium to the transport belt; and a processor configured to: cause the first detection section to detect a toner image secondarily transferred to the transport belt in a state where the recording medium is transported by the transport belt.

### CROSS-REFERENCE TO RELATED APPLICATIONS

This application is based on and claims priority under 35 USC 119 from Japanese Patent Application No. 2024-087497 filed May 29, 2024.

### BACKGROUND

### (i) Technical Field

The present disclosure relates to an image forming apparatus.

### (ii) Related Art

JP2007-292789A discloses an image forming apparatus that acquires a correction registration image created on a transport belt in an identical state to a state where an image is actually formed on paper, by forming the correction registration image on the transport belt in a state where the paper is placed on the transport belt.

JP2010-191064A discloses an image forming apparatus that can perform image adjustment without wasting paper possessed by a user, by transferring a toner pattern to an image adjustment sheet stored in the apparatus in a beltless direct transfer method.

### SUMMARY

Aspects of non-limiting embodiments of the present disclosure relate to an image forming apparatus that is capable of detecting a toner image that is secondarily transferred to a transport belt from all image forming units provided in the apparatus, under the same speed condition as in a case of transporting a recording medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a plurality of image forming units, each including a plurality of image forming sections and an intermediate transfer member on which a toner image formed by the plurality of image forming sections is primarily transferred; a transport belt that is capable of transporting a recording medium on which a toner image of the intermediate transfer member of each of the plurality of image forming units is secondarily transferred and that is capable of secondarily transferring the toner image of the intermediate transfer member of each of the plurality of image forming units; a first detection section that detects the toner image on a downstream side of a most downstream secondary transfer position; a recording medium supply section that supplies the recording medium to the transport belt; and a processor configured to: cause the first detection section to detect a toner image secondarily transferred to the transport belt in a state where the recording medium is transported by the transport belt.

### BRIEF DESCRIPTION OF THE DRAWINGS

Exemplary embodiment(s) of the present invention will be described in detail based on the following figures, wherein:

FIG. 1 is a diagram showing a configuration of an image forming apparatus according to a first exemplary embodiment;

FIG. 2 is a diagram showing a configuration of an image forming section in the above image forming apparatus;

FIGS. 3A to 3C are diagrams showing examples of a toner image for misalignment adjustment in the above image forming apparatus;

FIG. 4 is a diagram showing a configuration of an optical sensor in the above image forming apparatus;

FIG. 5 is a diagram showing a configuration of a control unit in the above image forming apparatus;

FIG. 6 is a diagram for describing a method of adjusting misalignment in the above image forming apparatus;

FIG. 7 is a flowchart for describing a flow of processing at time of the misalignment adjustment in the above image forming apparatus;

FIG. 8 is a graph showing a relationship between a misalignment amount in an intermediate transfer belt of an image forming unit and a misalignment amount in other portions;

FIG. 9 is a diagram for describing a paper transport state during detection by the optical sensor in the above image forming apparatus;

FIG. 10 is a graph for describing a difference between detection at a flat portion of a transport belt and detection at a local surface portion by the optical sensor.

FIGS. 11A to 11C are diagrams showing examples of a toner image for misalignment adjustment in an image forming apparatus according to a second exemplary embodiment.

FIG. 12 is a flowchart for describing a flow of processing at time of the misalignment adjustment in the above image forming apparatus; and

FIG. 13 is a diagram showing a configuration of an image forming apparatus according to another exemplary embodiment.

### DETAILED DESCRIPTION

### First Exemplary Embodiment

Hereinafter, a first exemplary embodiment of the present disclosure will be described in detail with reference to the accompanying drawings.

### Image Forming Apparatus

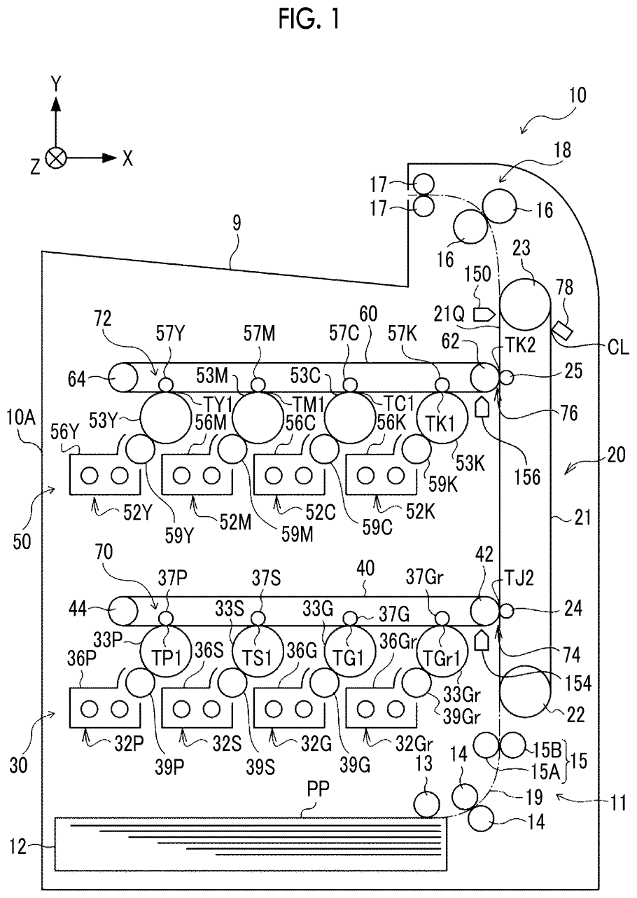

FIG. 1 is a diagram showing a configuration of an image forming apparatus 10 according to the first exemplary embodiment of the present disclosure. As shown in FIG. 1, the image forming apparatus 10 includes an accommodation section 12 in which paper PP is accommodated, a transport section 11 that transports the paper PP along a transport path 19, an image forming unit 30 and an image forming unit 50 that form a toner image to be transferred to the paper PP. The paper PP is an example of a recording medium in the technique of the present disclosure.

The accommodation section 12 can be pulled out from an image forming apparatus main body 10A that is an apparatus main body of the image forming apparatus 10, and accommodates the paper PP.

The transport section 11 includes a sending roll 13, a transport roll 14, a registration roll pair 15, a transport belt device 20, a fixing device 18, a discharge roll 17, and the like, in order from the upstream side in a transport direction.

The sending roll 13 sends out the paper PP accommodated in the accommodation section 12 to a transport path 19 constituting the transport section 11. The transport roll 14 transports the paper PP along the transport path 19.

The registration roll pair 15 transports the paper PP transported by the transport roll 14 to a secondary transfer position TJ2 on a downstream side which will be described later. The registration roll pair 15 sandwiches the paper PP between a registration roll 15A and a pinch roll 15B, and transports the paper PP to the downstream side in the transport direction.

The transport belt device 20 transports the paper PP to the downstream side in the transport direction along the transport path 19 while transferring a toner image formed by the image forming units 30 and 50 to the paper PP. The details of the transport belt device 20 will be described later.

The fixing device 18 includes a fixing roll pair 16, and in a case where the paper PP passes through the fixing roll pair 16, the fixing device 18 heats and pressurizes the paper PP to which the toner image is transferred, to fix the toner image on the paper PP.

The discharge roll 17 discharges the paper PP on which the toner image is fixed by the fixing device 18, to the discharge section 9.

The image forming unit 30 and the image forming unit 50 are arranged in the up-down direction. In the present exemplary embodiment, the image forming unit 50 is disposed above the image forming unit 30. From another point of view, the image forming unit 50 is disposed on the downstream side in the paper transport direction of the image forming unit 30.

The image forming unit 30 forms a toner image of a special color other than the basic colors of yellow (Y), magenta (M), cyan (C), and black (K), for example. The image forming unit 30 includes four image forming sections 32 and an endless intermediate transfer belt 40. The intermediate transfer belt 40 is mounted such that the toner images formed by the four image forming sections 32 are transferred, and the intermediate transfer belt 40 is rotatable counterclockwise in front view of FIG. 1.

The image forming section 32 includes, for example, an image forming section 32P that forms a toner image of a special pink color (P), an image forming section 32S that forms a toner image of a silver color(S), an image forming section 32G that forms a toner image of a gold color (G), and an image forming section 32Gr that forms a toner image of a special green color (Gr). The four image forming sections 32 are disposed in the order of the image forming section 32P, the image forming section 32S, the image forming section 32G, and the image forming section 32Gr in order from the upstream side in a rotation direction (the side close to a support roll 44 to be described later) in which the intermediate transfer belt 40 rotates.

An upstream side in a rotation direction of the intermediate transfer belt 40 is referred to as a “rotation-direction upstream side” below, and a downstream side in the rotation direction is referred to as a “rotation-direction downstream side” below. That is, in the image forming section 32, the image forming section 32Gr is disposed on the most downstream side in the rotation direction. In addition, in the image forming section 32, the image forming section 32Gr is disposed at a position closest to the secondary transfer position TJ2.

In a case where it is not necessary to distinguish between P, S, G, and Gr, P, S, G, and Gr are omitted.

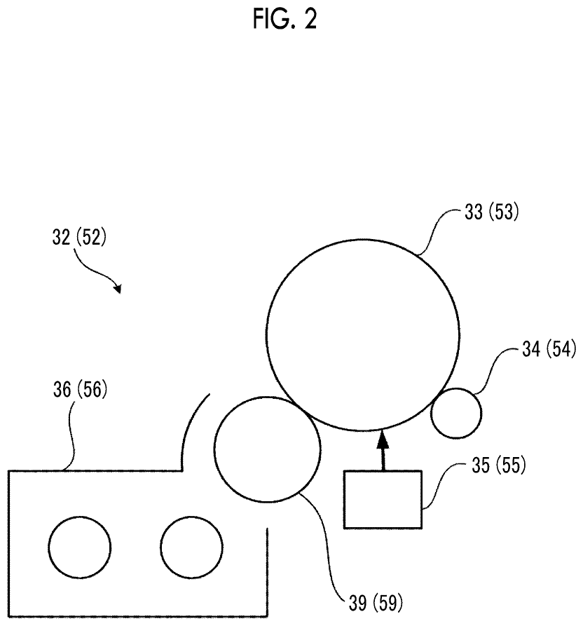

As shown in FIG. 2, the image forming section 32 includes the photoconductor 33, a charging member 34 that charges the surface of the photoconductor 33, an exposure device 35 that irradiates the charged photoconductor 33 with exposure light, and a developing device 36 that develops an electrostatic latent image formed by the irradiation with the exposure light to be visualized as a toner image. The developing device 36 includes a developing roll 39, and a developing bias is applied.

In addition, primary transfer rolls 37P, 37S, 37G, and 37Gr that transfer the toner image formed by the image forming section 32 to the intermediate transfer belt 40 are disposed at positions facing each photoconductor 33 with the intermediate transfer belt 40 interposed therebetween. The intermediate transfer belt 40 is wound around the support roll 44 that supports the intermediate transfer belt 40 and a backup roll 42 disposed in a secondary transfer section 74 on the upstream side, which will be described later. A primary transfer section 70 is configured to include the photoconductor 33, the primary transfer rolls 37, and the intermediate transfer belt 40. In addition, primary transfer positions TP1, TS1, TG1, and TGr1 are set between the photoconductors 33P, 33S, 33G, and 33Gr, and the intermediate transfer belt 40, respectively.

The image forming unit 50 has the similar configuration to the above-described image forming unit 30 except that colors for forming an image are different. The image forming unit 50 forms toner images of basic colors of yellow, magenta, cyan, and black, for example.

The image forming unit 50 includes four image forming sections 52 and an intermediate transfer belt 60. The intermediate transfer belt 60 is mounted such that the toner images formed by the four image forming sections 52 are transferred, and the intermediate transfer belt 60 is rotatable counterclockwise in front view of FIG. 1.

As shown in FIG. 2, the image forming section 52 has the similar configuration to the image forming section 32 of the image forming unit 30 except that colors for forming an image are different. Further, the intermediate transfer belt 60 and the primary transfer roll 57 described later have the similar configuration to the intermediate transfer belt 40 and the primary transfer roll 37 of the image forming unit 30. Further, the other constituent members constituting the image forming unit 50 are similar to the constituent members of the image forming unit 30.

The image forming section 52 includes an image forming section 52Y that forms a toner image of a yellow color, an image forming section 52M that forms a toner image of a magenta color, an image forming section 52C that forms a toner image of a cyan color, and an image forming section 52K that forms a toner image of a black color. The four image forming sections 52 are disposed in the order of the image forming section 52Y, the image forming section 52M, the image forming section 52C, and the image forming section 52K in order from the rotation direction upstream side (the side closer to a support roll 64 to be described later). That is, in the image forming section 52, the image forming section 52K is disposed on the most downstream side in the rotation direction. In addition, in the image forming section 52, the image forming section 52K is disposed at a position closest to a secondary transfer position TK2.

In a case where it is not necessary to distinguish between Y, M, C, and K, Y, M, C, and K are omitted.

The image forming section 52 includes a photoconductor 53, a charging member 54, an exposure device 55, and a developing device 56. The developing device 56 includes a developing roll 59, and a developing bias is applied.

Further, the primary transfer rolls 57Y, 57M, 57C, and 57K are disposed at positions facing respective photoconductors 53 with the intermediate transfer belt 60 interposed therebetween. The intermediate transfer belt 60 is wound around the support roll 64 and a backup roll 62 disposed in a secondary transfer section 76 on the downstream side, which will be described later. A primary transfer section 72 is configured to include the photoconductor 53, the primary transfer rolls 57, and the intermediate transfer belt 60. Further, primary transfer positions TY1, TM1, TC1, and TK1 are set between the photoconductors 53Y, 53M, 53C, and 53K and the intermediate transfer belt 60, respectively.

Next, the transport belt device 20 will be described in detail. As shown in FIG. 1, the transport belt device 20 includes an endless transport belt 21, support rolls 22 and 23 that support the transport belt 21, and secondary transfer rolls 24 and 25 that are disposed at positions facing the backup rolls 42 and 62 with the intermediate transfer belts 40 and 60 interposed between the backup rolls 42 and 62, and the secondary transfer rolls 24 and 25.

The secondary transfer roll 24 sandwiches the paper PP and the transport belt 21 between the secondary transfer roll 24 and the backup roll 42, and transfers the toner image formed on the intermediate transfer belt 40 of the image forming unit 30 to the paper PP. Similarly, the secondary transfer roll 25 sandwiches the paper PP and the transport belt 21 between the secondary transfer roll 25 and the backup roll 62, and transfers the toner image formed on the intermediate transfer belt 60 of the image forming unit 50 to the paper PP.

The secondary transfer section 74 is configured to include the backup roll 42, the secondary transfer roll 24, and the intermediate transfer belt 40. Further, the secondary transfer section 76 is configured to include the backup roll 62, the secondary transfer roll 25, and the intermediate transfer belt 60.

A transfer bias is applied to each of the secondary transfer rolls 24 and 25.

In addition, the secondary transfer position TJ2 is defined between the intermediate transfer belt 40 of the image forming unit 30 and the transport belt 21, and the secondary transfer position TK2 is defined between the intermediate transfer belt 60 of the image forming unit 50 and the transport belt 21. The secondary transfer position TK2 is the most downstream secondary transfer position.

In addition, the transport belt device 20 includes a belt cleaning device 78 that cleans the transport belt 21. The belt cleaning device 78 performs cleaning on the downstream side in the paper transport direction of the most downstream secondary transfer position TK2 and on the downstream side of an optical sensor 150 which will be described later. In the transport belt 21, a position to be cleaned by the belt cleaning device 78 is set as a cleaning position CL.

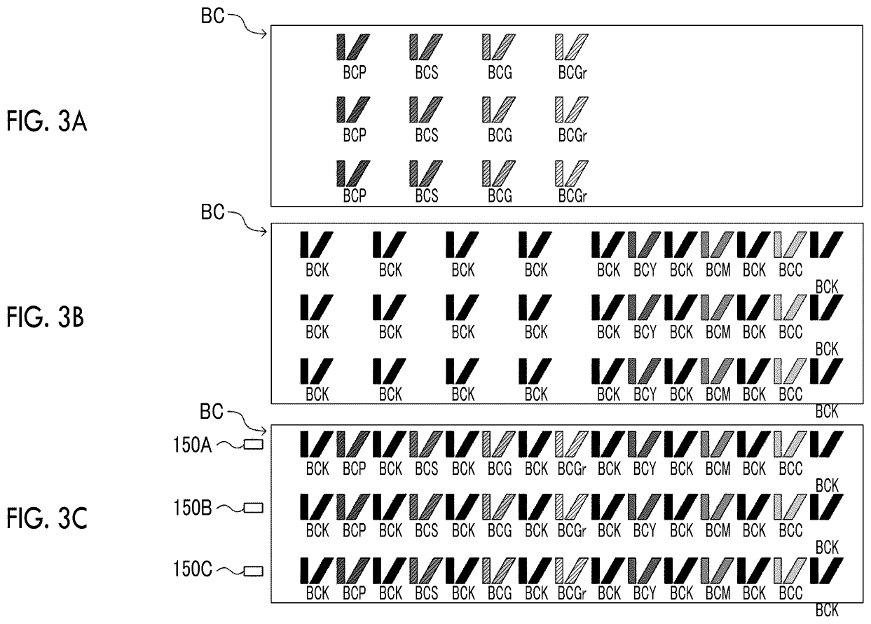

In the present exemplary embodiment, a toner image BC used for misalignment adjustment is a pattern shown in FIG. 3C.

The toner image BC includes eight colors of toner images, which are yellow, magenta, cyan, black, special color pink, silver, gold, and special color green. The toner images of the respective colors all have the same shape, and include a horizontal line extending in a main scanning direction (up-down direction in the drawing) in the image forming units 30 and 50 and an oblique line.

In the toner image BC, three row of patterns extending in a row in a sub-scanning direction (right-left direction in the drawing) in the image forming units 30 and 50 are disposed. The patterns of the respective rows are identical to each other, and a toner image BCK of a black color and toner images of colors other than the black color are alternately disposed. In addition, each toner image is disposed at equal intervals.

As described above, by using the three rows of the toner images BC extending in the sub-scanning direction, it is possible to independently adjust the misalignment at three places (for example, both end portions and the center portion) in the main scanning direction.

The toner image BC for misalignment adjustment is formed as follows. First, as shown in FIG. 3A, in the toner image BC, a toner image BCP of the special pink color, a toner image BCS of the silver color, a toner image BCG of the gold color, and a toner image BCGr of the special green color are primarily transferred to the intermediate transfer belt 40.

In addition, as shown in FIG. 3B, in the toner image BC, a toner image BCY of the yellow color, a toner image BCM of the magenta color, a toner image BCC of the cyan color, and the toner image BCK of the black color are primarily transferred to the intermediate transfer belt 60.

Finally, as shown in FIG. 3C, the toner image BC primarily transferred to the intermediate transfer belts 40 and 60 is secondarily transferred to the transport belt 21 to form the toner image BC for the misalignment adjustment.

As shown in FIG. 1, the optical sensor 150 as an example of a first detection section that detects the toner image BC secondarily transferred to the transport belt 21 is provided at a position facing a support roll 23 with the transport belt 21 interposed therebetween.

The optical sensor 150 is disposed on the downstream side of the most downstream secondary transfer position TK2. From another viewpoint, the optical sensor 150 is disposed at a position at which all the toner images BC formed by all the image forming sections 32Y, 32M, 32C, 32W, 52T, 52S, 52G, and 52K can be detected.

In addition, the optical sensor 150 detects the toner image BC at a flat portion 21Q between the secondary transfer position TK2 and the upper support roll 23 around which the transport belt 21 is wound. In the present exemplary embodiment, the optical sensor 150 detects the toner image BC at the position facing the support roll 23 at the flat portion 21Q.

The position of the optical sensor 150 is not limited to the above position. In the present exemplary embodiment, the optical sensor 150 only needs to be disposed at a position where the toner image BC can be detected on the upstream side in the rotation direction of the most downstream secondary transfer position TK2 and on the upstream side in the rotation direction of the cleaning position CL.

In addition, optical sensors 154 and 156 as an example of a second detection section that detects the toner image BC primarily transferred to the intermediate transfer belts 40 and 60 are provided in the image forming unit 30 and the image forming unit 50, respectively.

The optical sensor 154 provided in the image forming unit 30 detects the toner image BC in the vicinity of the backup roll 42 at a flat portion 40Q of the intermediate transfer belt 40 between a most downstream primary transfer position TW1 and the backup roll 42.

The optical sensor 156 provided in the image forming unit 50 detects the toner image BC in the vicinity of the backup roll 62 at a flat portion 60Q of the intermediate transfer belt 60 between the primary transfer position TK1 and the backup roll 62, at the most downstream primary transfer position TK1.

The optical sensor 150, the optical sensor 154, and the optical sensor 156 in the present exemplary embodiment have the same structure. In addition, the optical sensor 150, the optical sensor 154, and the optical sensor 156 detect the toner image BC at the same position in an axial direction (Z-direction in FIG. 1) of each roll.

The axial direction of each roll corresponds to the main scanning direction in the image forming units 30 and 50. In addition, the transport direction of the transport belt 21 corresponds to the sub-scanning direction in the image forming units 30 and 50.

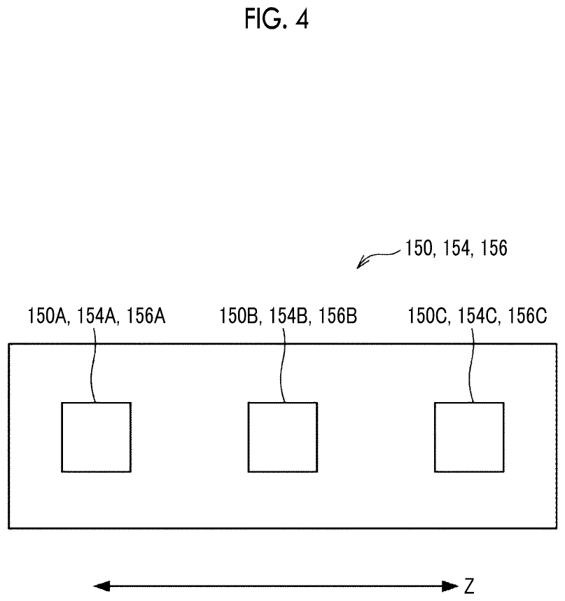

In addition, as shown in FIG. 4, the optical sensors 150, 154, and 156 in the present exemplary embodiment have three detection sections 150A, 154A, and 156A, detection sections 150B, 154B, and 156B, and detection sections 150C, 154C, and 156C arranged at intervals along the axial direction of each roll.

The detection sections 150A, 154A, and 156A, the detection sections 150B, 154B, and 156B, and the detection sections 150C, 154C, and 156C are disposed at positions corresponding to the respective rows of the toner image BC for the misalignment adjustment shown in FIGS. 3A to 3C.

### Control Unit

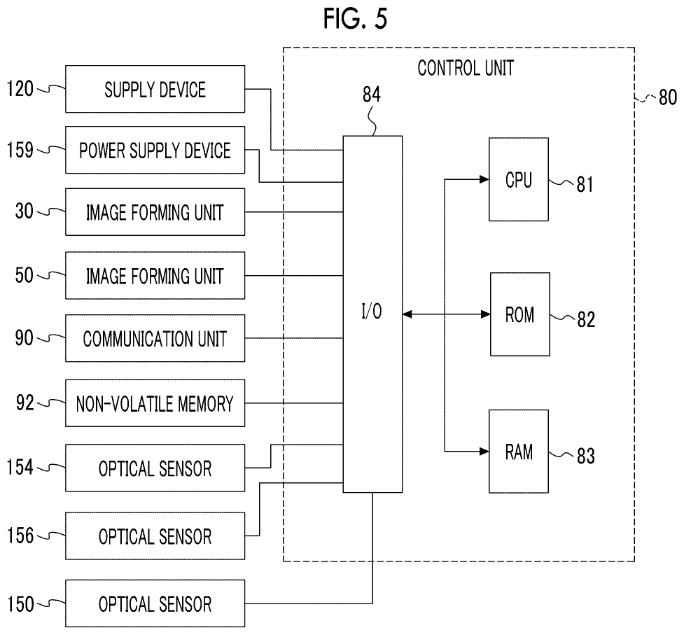

Next, a control unit 80 that controls the operation of the image forming apparatus 10 will be described with reference to FIG. 5.

As shown in FIG. 5, the image forming unit 30, the image forming unit 50, a communication unit 90, a non-volatile memory 92, a supply device 120, a power supply device 159, the optical sensor 150, 154, and 156, and the like are electrically connected to the control unit 80.

The control unit 80 is connected to a central processing unit (CPU) 81, a read only memory (ROM) 82, a random access memory (RAM) 83, and an input/output interface (I/O) 84 via a bus.

Here, the ROM 82 stores an image formation control program (not shown) to be executed by the CPU 81. Then, the CPU 81 reads the image formation control program (not shown) from the ROM 82 and expands the image formation control program into the RAM 83 to execute a printing process by the image formation control program (not shown).

Further, the image forming unit 30, the image forming unit 50, the communication unit 90, and the non-volatile memory 92 are connected to the I/O 84. The communication unit 90 is an interface for performing data communication between a terminal device such as a personal computer (not shown) and the image forming apparatus 10. The non-volatile memory 92 stores information necessary for the image forming apparatus 10 to perform an image forming operation.

The control unit 80 performs various controls for forming a toner image on the intermediate transfer belt 40 by the image forming section 32 of each color in the image forming unit 30. Similarly, the control unit 80 performs various controls for forming a toner image on the intermediate transfer belt 60 by the image forming section 52 of each color in the image forming unit 50.

In addition, the control unit 80 controls developing biases applied to the developing rolls 39 and 59 of the developing devices 36 and 56, respectively. Further, the control unit 80 controls transfer biases applied to the secondary transfer rolls 24 and 25, respectively.

In addition, the control unit 80 controls the supply timing, the supply time, the supply amount, and the like of the toner supply of each color toner from a toner cartridge of each color to the developing devices 36 and 56.

Further, a detection value obtained in a manner that the optical sensor 150 detects the toner image BC is input to the control unit 80. Based on the detection values, the control unit 80 controls timings of forming the toner images on the intermediate transfer belts 40 and 60 of the image forming units 30 and 50, specifically, controls exposure timings of the respective exposure device 35 and 55 and the like, and the control unit 80 controls the developing bias applied to each of the developing rolls 39 and 59, the transfer bias applied to the secondary transfer rolls 24 and 25, and the like.

Details of various controls based on the detection value obtained in a manner that the optical sensor 150 detects the toner image BC will be described later.

### Image Forming Step

Next, the outline of an image forming process in the image forming apparatus 10 will be described.

First, the control unit 80 controls each image forming section 32 such that a toner image is formed on the intermediate transfer belt 40 of the image forming unit 30. Similarly, the control unit 80 controls each image forming section 52 such that a toner image is formed on the intermediate transfer belt 60 of the image forming unit 50.

Specifically, the control unit 80 applies a voltage to the charging members 34 and 54, and charges the surfaces of the photoconductors 33 and 53 to have a predetermined potential, by using the charging members 34 and 54 to which a voltage is applied. Subsequently, the control unit 80 irradiates the surfaces of the photoconductors 33 and 53 charged by the charging members 34 and 54 with exposure light by the exposure devices 35 and 55 to form an electrostatic latent image, based on image data acquired through the communication unit 90. Thus, an electrostatic latent image corresponding to the image data is formed on the surfaces of the photoconductors 33 and 53.

Then, the control unit 80 develops the electrostatic latent image formed by the exposure devices 35 and 55 by the developing devices 36 and 56 and visualizes the electrostatic latent image as a toner image. Further, the control unit 80 superimposes and transfers the toner image formed on the surfaces of the photoconductors 33 and 53 of each color on the intermediate transfer belts 40 and 60, by the primary transfer rolls 37 and 57.

In this manner, a toner image obtained by superimposing toners of, for example, a special pink color, a silver color, a gold color, and a special green color is formed on the intermediate transfer belt 40 in the image forming unit 30. Similarly, a toner image obtained by superimposing toners of, for example, a yellow color, a magenta color, a cyan color, and a black color is formed on the intermediate transfer belt 60 in the image forming unit 50.

In a case where the toner image is transferred to the transport belt 21, a transfer region on the transport belt 21 is sent to the secondary transfer position TJ2 based on the control of the control unit 80. At the secondary transfer position TJ2, the transport belt 21 is transported between the backup roll 42 and the secondary transfer roll 24, so that the toner image on the outer peripheral surface of the intermediate transfer belt 40 is transferred to the transport belt 21. Then, the transfer region on the transport belt 21, in which the toner image is transferred, is transported to the downstream side in the transport direction and reaches the secondary transfer position TK2 on the downstream side in the transport direction.

At this time, the control unit 80 adjusts the timing to start image formation such that the toner image formed on the intermediate transfer belt 60 of the image forming unit 50 is superimposed and transferred on the toner image on the transfer region on the transport belt 21 transported from the upstream side in the transport direction.

In addition, in a case where the toner image is transferred to the paper PP, the paper PP sent from the accommodation section 12 to the transport path 19 by the sending roll 13 is sent to the secondary transfer position TJ2 after the transport timing is adjusted by the registration roll pair 15, based on the control of the control unit 80. At the secondary transfer position TJ2, the paper PP is transported between the backup roll 42 and the secondary transfer roll 24, so that the toner image on the outer peripheral surface of the intermediate transfer belt 40 is transferred to the paper PP. Then, the paper PP on which the toner image is transferred is transported to the downstream side in the transport direction and reaches the secondary transfer position TK2 on the downstream side in the transport direction.

At this time, the control unit 80 adjusts the timing to start image formation such that the toner image formed on the intermediate transfer belt 60 of the image forming unit 50 is superimposed and transferred on the toner image on the paper PP transported from the upstream side in the transport direction.

The paper PP, on which the toner images of the respective colors formed by the image forming unit 30 and the image forming unit 50 are superimposed and transferred, is fixed by the fixing roll pair 16 of the fixing device 18, and then is discharged to the discharge section 9 provided at the upper portion of an image forming apparatus main body 10A, by the discharge roll 17.

### Adjustment of Misalignment

Next, a so-called color registration control of adjusting misalignment in the sub-scanning direction of an image obtained by superimposing toner images of the respective colors that are the special pink color, the silver color, the gold color, the special green color, the yellow color, the magenta color, the cyan color, and the black color, which are formed by the respective image forming sections 32 in the image forming unit 30 and the respective image forming sections 52 in the image forming unit 50, will be described. The color registration control in the present exemplary embodiment is performed at the exposure timings of the exposure devices 35 and 55.

Specifically, the optical sensor 150 detects the toner image BC for the misalignment adjustment, which is transferred to the transport belt 21, and exposure timings of the exposure devices 35P, 35S, 35G, 35Gr, 55Y, 55M, 55C, and 55K are adjusted such that the toner image BC is located at a predetermined position.

The misalignment may be adjusted by any method, and, in the present exemplary embodiment, the misalignment is adjusted as follows.

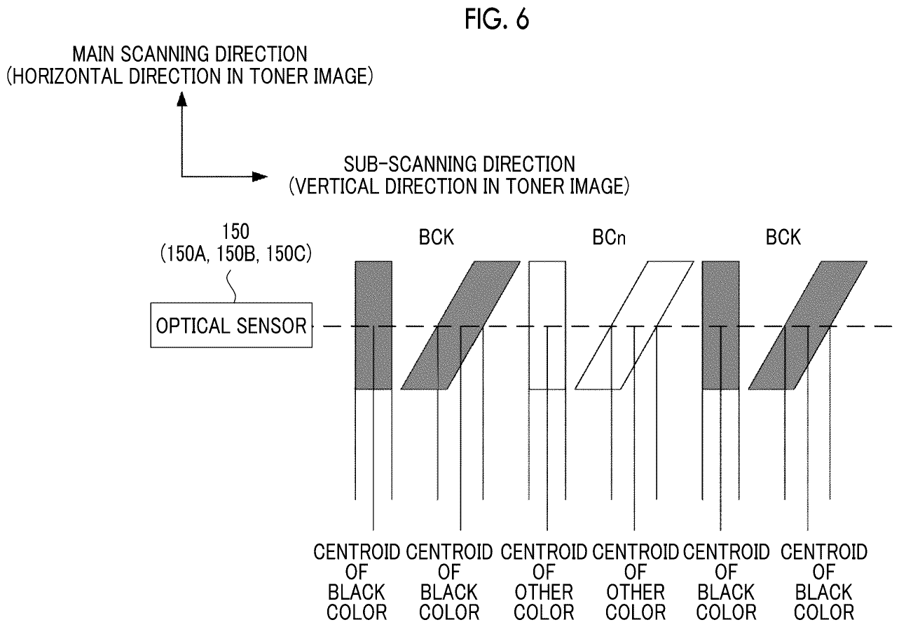

In the present exemplary embodiment, as shown in FIG. 6, the misalignment is adjusted by using, as a reference, the toner image BCK of the black color in the toner image BC for the misalignment adjustment. Specifically, the misalignment is adjusted as follows for the toner image of the color (referred to as a toner image BCn of another color below) interposed between the two black toner images BCK.

### Shift in Main Scanning Direction

“Intermediate position between the centroid positions of the oblique lines of the two black toner images BCK”—“Centroid position of the oblique line of the color toner image BCn of the other color”—“Shift in the sub-scanning direction”

### Shift in Sub-Scanning Direction

“Intermediate position between the centroid positions of the horizontal lines of the two black toner images BCK”—“Centroid position of the horizontal line of the color toner image BCn of the other color”

The above adjustment is performed for the special pink color, the silver color, the gold color, the special green color, the yellow color, the magenta color, and the cyan color, excluding the black color.

### Actions

Next, actions of the image forming apparatus 10 in the present exemplary embodiment will be described.

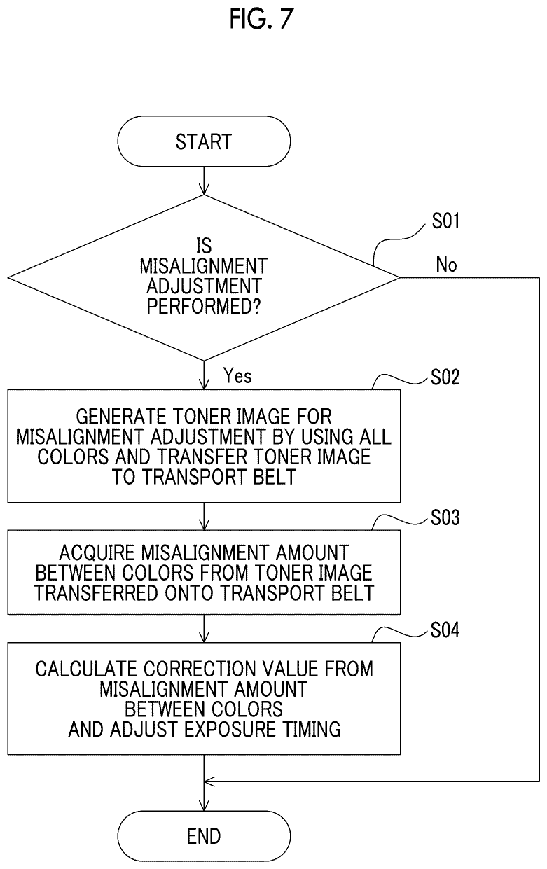

A flow of processing during the adjustment of the misalignment in the image forming apparatus 10 in the present exemplary embodiment is as shown in the flowchart of FIG. 7.

First, in Step S01, the control unit 80 determines whether or not to perform the misalignment adjustment. In a case where it is determined in Step S01 not to perform the misalignment adjustment, the control unit 80 ends the processing.

In a case where it is determined in Step S01 to perform the misalignment adjustment, in Step S02, the control unit 80 generates a toner image BC for the misalignment adjustment by using all colors and transfers the toner image BC to the transport belt 21.

Then, in Step S03, the control unit 80 acquires a misalignment amount between colors from the toner image BC transferred onto the transport belt 21 by using the optical sensor 150.

Finally, in Step S04, the control unit 80 calculates a correction value from the misalignment amount between the colors, adjusts the exposure timings of the exposure devices 35P, 35S, 35G, 35Gr, 55Y, 55M, 55C, and 55K, and ends the processing.

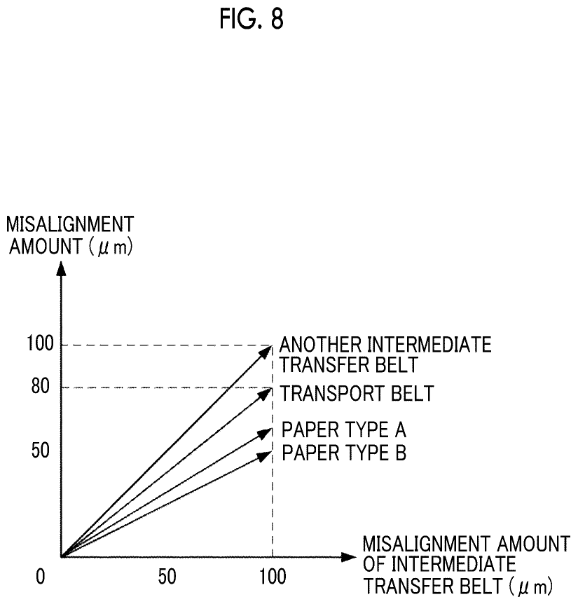

Here, a relationship between the misalignment amount in the intermediate transfer belts 40 and 60 and the misalignment amount in other portions in each of the image forming units 30 and 50 is as shown in the graph of FIG. 8. In the graph of FIG. 8, the horizontal axis indicates the misalignment amount (μm) in the intermediate transfer belt, and the vertical axis indicates the misalignment amount (μm) in the other portion.

As shown in the graph of FIG. 8, in a case where there is a condition that the other intermediate transfer belt also has the same load as the misalignment amounts of the reference color and the other colors on the intermediate transfer belt, the substantially identical misalignment amount is obtained.

In addition, in a case where the speed of the transport belt 21 is slower than the speeds of the intermediate transfer belts 40 and 60, the misalignment amount is reduced.

In the case of the relationship of the above-described example, in a case where the misalignment amount of about 80 μm in the transport belt 21 is detected, the correction amount during the primary transfer to the intermediate transfer belts 40 and 60 needs to be set to about 100 μm.

In addition, in a case where the paper PP is transported by the transport belt 21, the degree of change in the misalignment amount varies depending on the paper condition. This is because, in a case where the paper PP is transported by the transport belt 21, the speed of the transport belt 21 is changed due to the influence of, for example, the shape and/or the weight of the paper PP.

That is, in a state where the paper PP is not transported by the transport belt 21, it is not possible to accurately adjust the misalignment in a case of transferring the toner image to the paper PP with the detection value obtained in a manner that the optical sensor 150 detects the toner image BC transferred to the transport belt 21.

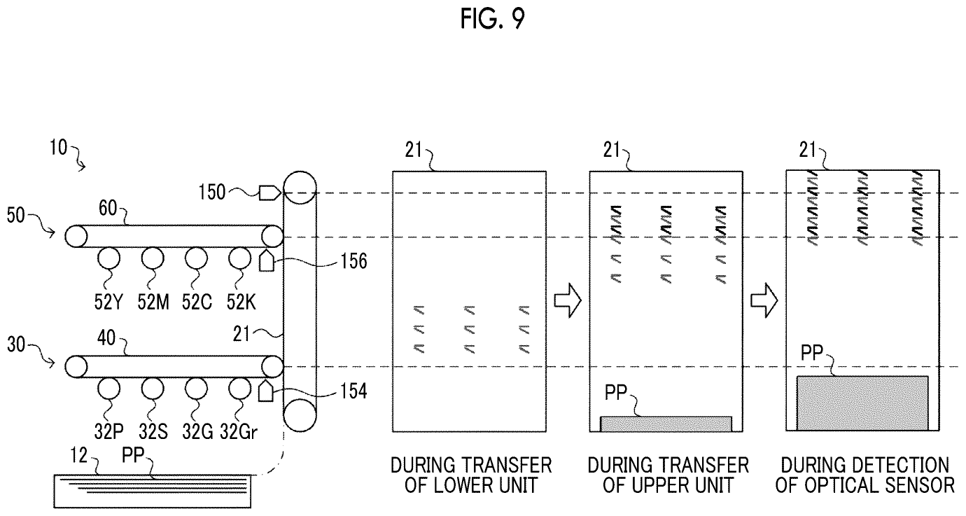

In order to address such a problem, in the image forming apparatus 10 in the present exemplary embodiment, as shown in FIG. 9, the optical sensor 150 detects the toner image BC secondarily transferred to the transport belt 21, in a state where the paper PP is transported by the transport belt 21.

Specifically, the secondary transfer of the toner image BC from the intermediate transfer belt 40 of the lower image forming unit 30 to the transport belt 21 is completed and the paper PP is supplied to the transport belt 21 from the lower image forming unit 30 before the toner image BC is detected by the optical sensor 150.

As a result, in a case where the toner image BC is detected by the optical sensor 150, the speed of the transport belt 21 is the same as the speed of the transport belt 21 in a case where the toner image is transferred to the paper PP.

Thus, by using the detection value obtained in a manner that the optical sensor 150 detects the toner image BC transferred to the transport belt 21 under such conditions, it is possible to accurately adjust the misalignment in a case of transferring the toner image to the paper PP.

In addition, in the image forming apparatus 10 in the present exemplary embodiment, the optical sensor 150 is configured to detect the toner image BC at the flat portion 21Q of the transport belt 21.

Here, the difference between the detection at the flat portion 21Q of the transport belt 21 and the detection at the local surface portion will be described.

In a case where the detection is performed at the local surface portion of the transport belt 21 by the optical sensor 150, the intensity of light detected by the optical sensor 150 is reduced, so that it is necessary to increase the intensity of light emitted by the optical sensor 150 as compared with the case of the detection at the flat portion 21Q.

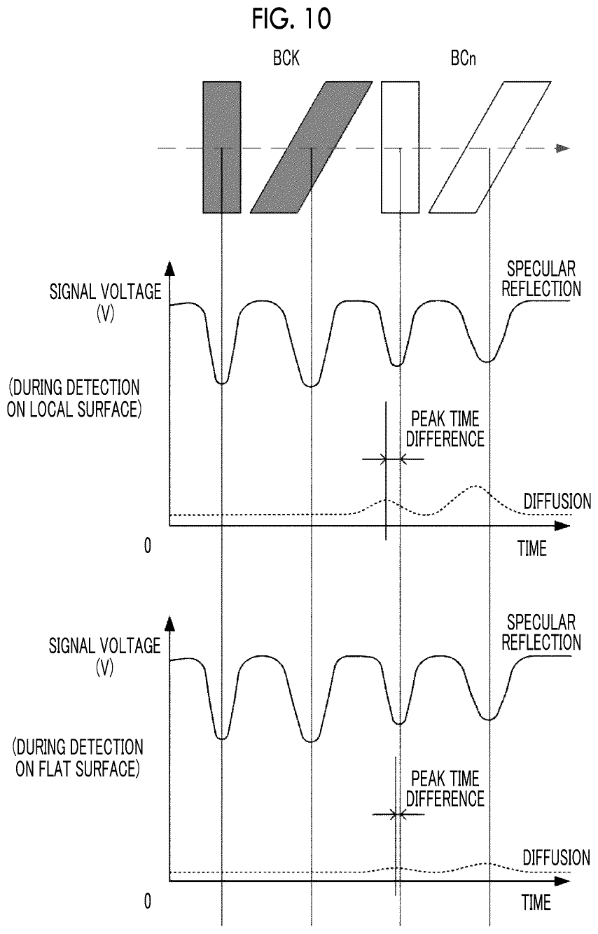

As a result, as shown in FIG. 10, in a case of detection at the local surface portion, as compared with the detection at the flat portion 21Q, the magnitude of the diffused waveform with respect to the magnitude of the specular reflection waveform that is the detection waveform of the toner image BC is increased. In addition, the time difference between the peak position of the specular reflection waveform and the peak position of the diffused waveform is also increased.

Therefore, as in the present exemplary embodiment, by performing detection at the flat portion 21Q of the transport belt 21, it is possible to accurately detect the toner image BC as compared with a case of detection at the local surface portion.

In addition, in the image forming apparatus 10 in the present exemplary embodiment, the optical sensor 150 is configured to detect the toner image BC at the position facing the support roll 23.

In this case, the deflection of the transport belt 21 during the detection is suppressed as compared with a case where the toner image BC is detected at a portion where there is nothing on the back side of the transport belt 21 as viewed from the optical sensor 150. Therefore, it is possible to accurately detect the toner image BC as compared with a case where the toner image BC is detected at the portion where there is nothing on the back side of the transport belt 21 as viewed from the optical sensor 150.

### Second Exemplary Embodiment

Next, a second exemplary embodiment of the present disclosure will be described. In the first exemplary embodiment, the aspect in which the misalignment adjustment is performed based on a detection signal of the toner image BC by the optical sensor 150 has been described. On the other hand, in the second exemplary embodiment, an aspect in which the misalignment adjustment is performed based on detection signals of the toner image BC by the optical sensors 150, 154, and 156 will be described. The configuration of an image forming apparatus 10 in the second exemplary embodiment is the same as the configuration of the image forming apparatus 10 in the first exemplary embodiment, and thus the description thereof will be omitted.

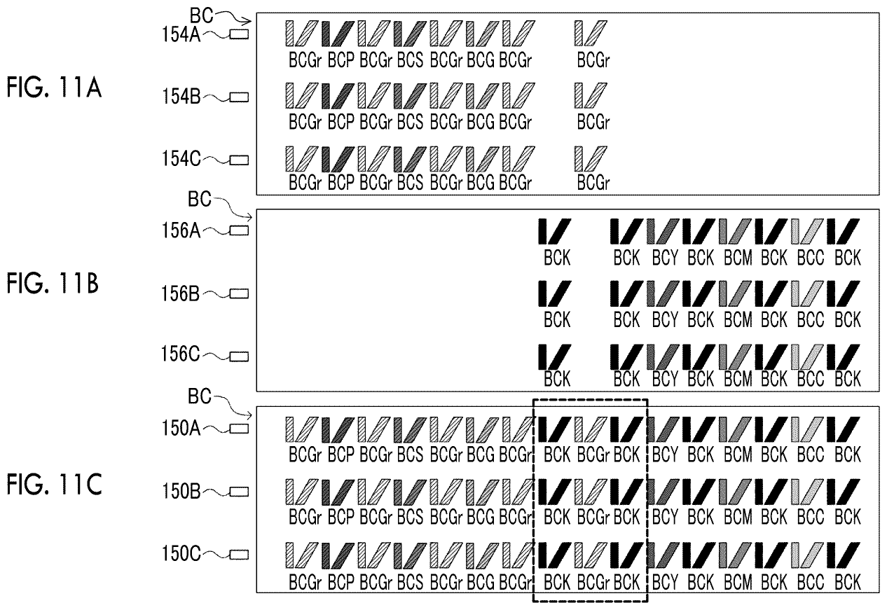

In the present exemplary embodiment, a toner image BC used for misalignment adjustment is a pattern shown in FIG. 11C.

The toner image BC includes eight colors of toner images, which are yellow, magenta, cyan, black, special color pink, silver, gold, and special color green. The toner images of the respective colors all have the same shape, and include a horizontal line extending in a main scanning direction (up-down direction in the drawing) in the image forming units 30 and 50 and an oblique line.

In the toner image BC, three row of patterns extending in a row in a sub-scanning direction (right-left direction in the drawing) in the image forming units 30 and 50 are disposed. The patterns of the respective rows are the same.

The toner image BC for misalignment adjustment is formed as follows. First, as shown in FIG. 11A, in the toner image BC, a toner image BCP of the special pink color, a toner image BCS of the silver color, a toner image BCG of the gold color, and a toner image BCGr of the special green color are primarily transferred to the intermediate transfer belt 40.

In the toner image BC primarily transferred to the intermediate transfer belt 40, the toner image BCGr of the special green color and the toner image other than the special green color are alternately disposed.

In addition, as shown in FIG. 11B, in the toner image BC, a toner image BCY of the yellow color, a toner image BCM of the magenta color, a toner image BCC of the cyan color, and the toner image BCK of the black color are primarily transferred to the intermediate transfer belt 60.

In the toner image BC primarily transferred to the intermediate transfer belt 60, the toner image BCK of the black color and the toner image other than the black color are alternately disposed.

Finally, as shown in FIG. 11C, the toner image BC primarily transferred to the intermediate transfer belts 40 and 60 is secondarily transferred to the transport belt 21 to form the toner image BC for the misalignment adjustment.

In the toner image BC secondarily transferred to the transport belt 21, in a region surrounded by the broken line in FIG. 11C, the toner image BCGr of the special green color is disposed between the two toner images BCK of the black color. In addition, in the toner image BC secondarily transferred to the transport belt 21, the respective toner images are arranged at equal intervals.

Next, actions of the image forming apparatus 10 in the present exemplary embodiment will be described.

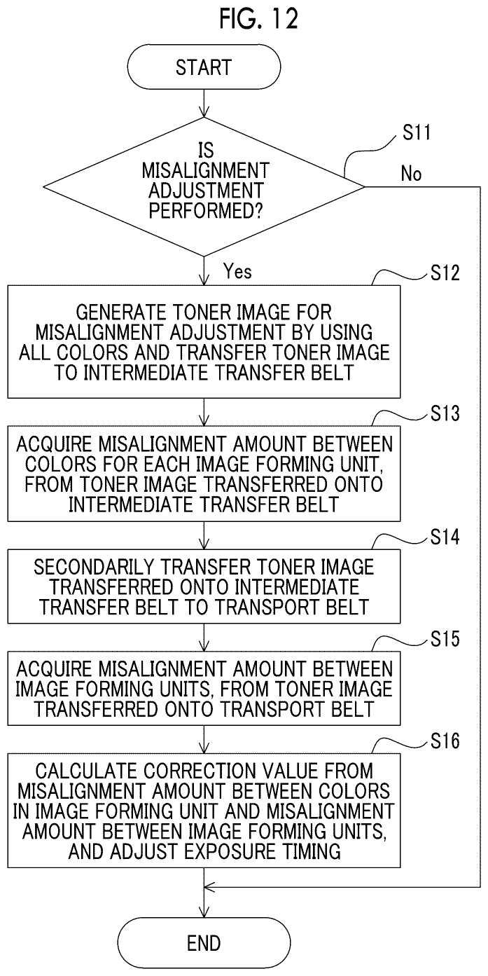

A flow of processing during the adjustment of the misalignment in the image forming apparatus 10 in the present exemplary embodiment is as shown in the flowchart of FIG. 12.

First, in Step S11, the control unit 80 determines whether or not to perform the misalignment adjustment. In a case where it is determined in Step S11 not to perform the misalignment adjustment, the control unit 80 ends the processing.

In a case where it is determined in Step S11 to perform the misalignment adjustment, in Step S12, the control unit 80 generates a toner image BC for the misalignment adjustment by using all colors and primarily transfers the toner image BC to the intermediate transfer belts 40 and 60.

Then, in Step S13, the control unit 80 acquires the misalignment amount between colors for each of the image forming units 30 and 50 from the toner images transferred onto the intermediate transfer belts 40 and 60 by using the optical sensors 154 and 156.

Here, in a case of acquiring the misalignment amount between colors in the image forming unit 30, the misalignment amount of the toner image of the color other than the special green color is acquired by using, as a reference, the toner image BCGr of the special green color. In addition, in a case of acquiring the misalignment amount between colors in the image forming unit 50, the misalignment amount of the toner image of the color other than the black color is acquired by using, as a reference, the toner image BCK of the black color.

Then, in Step S14, the control unit 80 secondarily transfers the toner image transferred onto the intermediate transfer belts 40 and 60 to the transport belt 21.

Then, in Step S15, the control unit 80 acquires a misalignment amount between the image forming units 30 and 50 from the toner image transferred onto the transport belt 21 by using the optical sensor 150.

Here, in a case of acquiring the misalignment amount between the image forming units 30 and 50, in the region surrounded by the broken line in FIG. 11C, the misalignment amount of the toner image BCGr of the special green color formed by the image forming unit 30 is acquired by using, as a reference, the toner image BCK of the black color formed by the image forming unit 50.

Finally, in Step S16, the control unit 80 calculates the correction value from the misalignment amount between the colors in the image forming units 30 and 50 and the misalignment amount between the image forming units 30 and 50, adjusts the exposure timings of the exposure devices 35P, 35S, 35G, 35Gr, 55Y, 55M, 55C, and 55K, and then ends the processing.

As described above, by using the optical sensors 154 and 156 provided in the image forming units 30 and 50, the misalignment amount between colors can be adjusted for each of the image forming units 30 and 50.

In addition, in the image forming apparatus 10 in the present exemplary embodiment, the control unit 80 may cause the optical sensors 150, 154, and 156 to detect a new toner image BC for the misalignment adjustment in a case where a condition in which the update of the misalignment correction value is required is satisfied.

Here, for example, the following cases are considered as the “condition in which the update of the misalignment correction value is required”. A first condition is a case where the misalignment correction value is in an initial state. A second condition is a case where either the image forming units 30 or 50 is attached to, detached from, or exchanged after the previous adjustment execution. A third condition is a case where the transport belt device 20 is attached to, detached from, or exchanged after the previous adjustment execution. In addition, other conditions may be used.

In addition, the optical sensors 150, 154, and 156 are configured to detect the toner image at the same position in a direction perpendicular to the transport direction of the transport belt 21.

As a result, it is possible to adjust the misalignment amount between colors with high accuracy as compared with a case where the optical sensors 150, 154, and 156 detect the toner image at different positions in the direction perpendicular to the transport direction of the transport belt 21.

### Modification Examples

Although the image forming apparatus 10 which is one exemplary embodiment of the information processing system according to the present disclosure has been described above, the technique of the present disclosure is not limited to the above-described exemplary embodiments and can be modified as appropriate.

For example, the number of image forming units provided in the image forming apparatus 10 is not limited to two, and may be three or more.

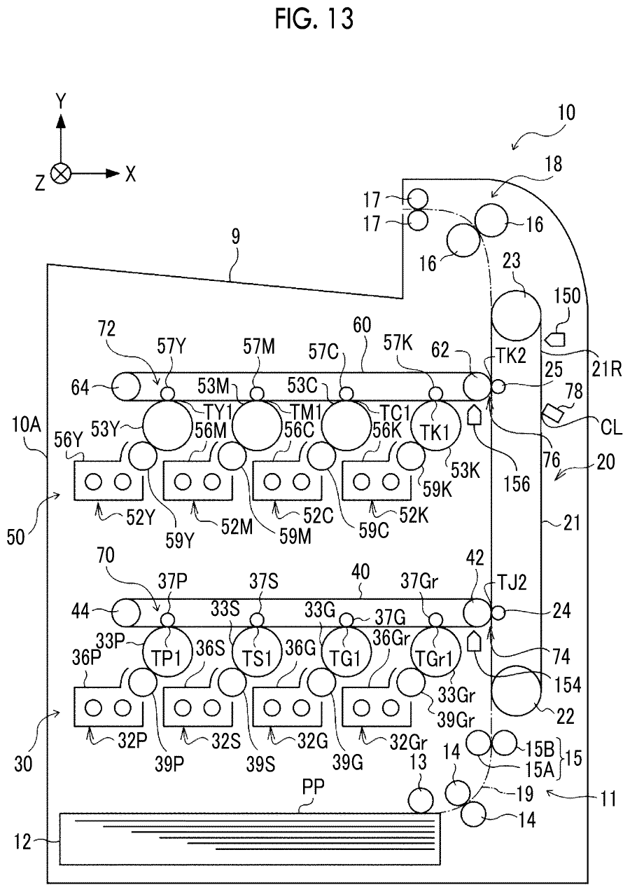

In addition, as shown in FIG. 13, the optical sensor 150 may be disposed at a position of the flat portion 21R of the transport belt 21, which is located on the side opposite to the secondary transfer positions TJ2 and TK2 with the support rolls 22 and 23 interposed therebetween, where the toner image BC is detected.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Notes

Regarding the exemplary embodiments described above, the following supplementary notes are further disclosed.

(((1)))

An image forming apparatus comprising:
a plurality of image forming units, each including a plurality of image forming sections and an intermediate transfer member on which a toner image formed by the plurality of image forming sections is primarily transferred;
a transport belt that is capable of transporting a recording medium on which a toner image of the intermediate transfer member of each of the plurality of image forming units is secondarily transferred and that is capable of secondarily transferring the toner image of the intermediate transfer member of each of the plurality of image forming units;
a first detection section that detects the toner image on a downstream side of a most downstream secondary transfer position;
a recording medium supply section that supplies the recording medium to the transport belt; and
a processor configured to:
   cause the first detection section to detect a toner image secondarily transferred to the transport belt in a state where the recording medium is transported by the transport belt.
      (((2)))

The image forming apparatus according to (((1))), further comprising:
a second detection section that is provided in at least one of the image forming units and detects a toner image between a most downstream primary transfer position and a secondary transfer position in the intermediate transfer member.
   (((3)))

The image forming apparatus according to (((2))), wherein the processor is configured to:
acquire a misalignment correction value by using both detection results of the first detection section and the second detection section, and adjust misalignment of a toner image formed on a recording medium by secondarily transferring the toner image of the intermediate transfer member of each of the plurality of image forming units by using the acquired misalignment correction value; and
in a case where a condition that update of the misalignment correction value is required is satisfied, cause the first detection section and the second detection section to detect a new toner image.
   (((4)))

The image forming apparatus according to (((2))) or (((3))),
wherein the first detection section and the second detection section detect a toner image at the same position in a direction perpendicular to a transport direction of the transport belt.
   (((5))

The image forming apparatus according to any one of (((1))) to (4))),
wherein the first detection section is disposed at a position where the transport belt is flat and the toner image is detected.
   (((6))

The image forming apparatus according to (((5))), further comprising:
a roll that is in contact with a belt surface of the transport belt, at a position facing the first detection section with the transport belt interposed between the roll and the first detection section.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of image forming units, each including a plurality of image forming sections and an intermediate transfer member on which a toner image formed by the plurality of image forming sections is primarily transferred;
a transport belt that is capable of transporting a recording medium on which a toner image of the intermediate transfer member of each of the plurality of image forming units is secondarily transferred and that is capable of secondarily transferring the toner image of the intermediate transfer member of each of the plurality of image forming units;
a first detection section that detects the toner image on a downstream side of a most downstream secondary transfer position;
a recording medium supply section that supplies the recording medium to the transport belt; and
a processor configured to:
cause the first detection section to detect a toner image secondarily transferred to the transport belt in a state where the recording medium is transported by the transport belt.

2. The image forming apparatus according to claim 1, further comprising:
a second detection section that is provided in at least one of the image forming units and detects a toner image between a most downstream primary transfer position and a secondary transfer position in the intermediate transfer member.

3. The image forming apparatus according to claim 2, wherein the processor is configured to:
acquire a misalignment correction value by using both detection results of the first detection section and the second detection section, and adjust misalignment of a toner image formed on a recording medium by secondarily transferring the toner image of the intermediate transfer member of each of the plurality of image forming units by using the acquired misalignment correction value; and
in a case where a condition that update of the misalignment correction value is required is satisfied, cause the first detection section and the second detection section to detect a new toner image.

4. The image forming apparatus according to claim 2,
wherein the first detection section and the second detection section detect a toner image at the same position in a direction perpendicular to a transport direction of the transport belt.

5. The image forming apparatus according to claim 1,
wherein the first detection section is disposed at a position where the transport belt is flat and the toner image is detected.

6. The image forming apparatus according to claim 5, further comprising:
a roll that is in contact with a belt surface of the transport belt, at a position facing the first detection section with the transport belt interposed between the roll and the first detection section.

7. An image forming apparatus comprising:
a plurality of image forming units, each including a plurality of image forming sections and an intermediate transfer member on which a toner image formed by the plurality of image forming sections is primarily transferred;
a transport belt that is capable of transporting a recording medium on which a toner image of the intermediate transfer member of each of the plurality of image forming units is secondarily transferred and that is capable of secondarily transferring the toner image of the intermediate transfer member of each of the plurality of image forming units;
a first detection section that detects the toner image on a downstream side of a most downstream secondary transfer position;
a recording medium supply section that supplies the recording medium to the transport belt; and
means for detecting, by the first detection section, a toner image secondarily transferred to the transport belt in a state where the recording medium is transported by the transport belt.
